(19) United States
(12) Patent Application Publication
(10) Pub. No.: US 2018/0269009 A1
(43) Pub. Date: Sep. 20, 2018

(54) SLIDE SWITCH

(71) Applicant: Primax Electronics Ltd., Taipei (TW)

(72) Inventors: CHENG -YI TSAI, Taipei (TW); YING-CHE TSENG, Taipei (TW); A-MING CHANG, Taipei (TW)

(21) Appl. No.: 15/655,312

(22) Filed: Jul. 20, 2017

(30) Foreign Application Priority Data
Mar. 17, 2017 (TW) 106203798

(51) Int. Cl. H01H 1/40; H01H 15/06; H01H 15/00

(52) U.S. Cl. CPC H01H 1/403; H01H 15/005; H01H 15/06

(57) ABSTRACT

A slide switch includes a circuit board assembly, a sensing element and a slider member. The circuit board assembly has an opening. The sensing element is installed on the circuit board assembly and electrically connected with the circuit board assembly. The slider member is movably connected with the circuit board assembly. The slider member is movable along the circuit board assembly. The slider member includes a slider plate and a supporting post. The supporting post is protruded from the slider plate. The slider plate includes a pressing part for pressing the sensing element. The supporting post is movable to a position within the opening. Consequently, the layout space of the slide switch is saved.

### FIELD OF THE INVENTION

The present invention relates to slide switch.

### BACKGROUND OF THE INVENTION

Nowadays, a slide switch is widely used in an electronic device such as a mouse, a keyboard, a flashlight or a remote control car. Conventionally, the slide switch is used to switch the electronic device between an on state and an off state. Alternatively, the slide switch is used as a changeover switch for switching the electronic device between two operation modes. As the volume of the electronic device is gradually decreased, the volume of the slide switch used in the electronic device is gradually decreased.

A conventional slide switch mainly comprises a casing, a slider, a movable connection element, a position-limiting element, a circuit board and a switching element. An elongated slot is formed in a top side of the casing. The slider is installed on the casing. Moreover, a bottom end of the slider is penetrated through the elongated slot. The movable connection element, the position-limiting element, the circuit board and the switching element are installed within the casing. A top end of the movable connection element is connected with the slider. A bottom end of the movable connection element is penetrated through the position-limiting element and connected with the switching element. The switching element is disposed on the circuit board and electrically connected with the circuit board.

Since the structure of the slide switch is complicated and the slide switch has a large number of components, the slide switch occupies a lot of volume space of the electronic device. As the trend of designing the electronic device is toward miniaturization, the conventional slide switch is not user-friendly. In other words, the conventional slide switch needs to be further improved.

### SUMMARY OF THE INVENTION

The present invention provides a slide switch.

In accordance with an aspect of the present invention, there is provided a slide switch. The slide switch is installed in a casing. The slide switch includes a circuit board assembly, a sensing element and a slider member. The circuit board assembly is fixed in the casing. The circuit board assembly has an opening. The sensing element is installed on the circuit board assembly and electrically connected with the circuit board assembly. The sensing element is on a first side of the opening. The slider member is movably connected with the circuit board assembly and located away from the sensing element. The slider member is movable along the circuit board assembly. The slider member comprises a slider plate and a supporting post. The supporting post is protruded from the slider plate in a direction toward the circuit board assembly. The slider plate includes a pressing part for pressing the sensing element. The supporting post is on a second side of the opening away from the sensing element. The supporting post is movable to a position within the opening. Preferably, the sensing element is a tact switch. Consequently, the layout space of the slide switch is saved.

In an embodiment, the circuit board assembly includes a main circuit board, and the opening is formed in the main circuit board. The sensing element is installed on the main circuit board and electrically connected with the main circuit board. The slider member is movably connected with the main circuit board and movable along the main circuit board. Preferably, the main circuit board further includes a perforation between the opening and the sensing element, and the slider member further includes a supporting arm. The supporting arm is protruded from the slider plate in a direction toward the main circuit board. The supporting arm is arranged between the supporting post and the pressing part. The supporting arm is movable to a position within the perforation. In an embodiment, a first guiding slant is formed on a lower part of the supporting post and at a side away from the sensing element, a second guiding slant is formed on a lower part of the supporting arm and at a side away from the sensing element, a first upper corner is located in the opening of the main circuit board, and a second upper corner is formed in the perforation of the main circuit board. The first guiding slant and the first upper corner are movably connected with each other. The second guiding slant and the second upper corner are movably connected with each other. In an embodiment, the slider member further includes an operation part. The operation part is connected with the slider plate and disposed on a top surface of the slider plate. In an embodiment, the slider member further includes a restoring element, and the restoring element is sheathed around the sensing element. An end of the restoring element away from the sensing element is pressed by the pressing part. An example of the restoring element is a spring. Consequently, the labor-saving efficacy is enhanced.

In an embodiment, the circuit board assembly includes a main circuit board and an auxiliary circuit board. The auxiliary circuit board is located under the main circuit board, the auxiliary circuit board is electrically connected with the main circuit board, and the opening is formed in the main circuit board. The sensing element is installed on the auxiliary circuit board and electrically connected with the auxiliary circuit board. The slider member is movably connected with the main circuit board and movable along the main circuit board. Preferably, the pressing part further includes a pressing post, and the pressing post is protruded from the slider plate in a direction toward the main circuit board. The sensing element beside the main circuit board is permitted to be pressed by the pressing post. In an embodiment, the slider member further includes a supporting arm. The supporting arm is protruded from the slider plate in a direction toward the main circuit board. The supporting arm is arranged between the supporting post and the pressing post. The supporting arm and an edge of the main circuit board close to the sensing element are movably connected with each other. In an embodiment, a first guiding slant is formed on a lower part of the supporting post and at a side away from the sensing element, a second guiding slant is formed on a lower part of the supporting arm and at a side away from the sensing element, a first upper corner is located in the opening of the main circuit board, and a second upper corner is formed on the edge of the main circuit board close to the sensing element. The first guiding slant and the first upper corner are movably connected with each other. The second guiding slant and the second upper corner are movably connected with each other. Consequently, the efficacy of saving the horizontal layout space is achieved. In an embodiment, the slider member further includes an operation part. The operation part is connected with the slider plate and disposed on a top surface of the slider plate. In an embodiment, the slider member further includes a restoring element, and the restoring element is sheathed around the sensing element. An end of the restoring element away from the sensing element is pressed by the pressing part. An example of the restoring element is a spring. Consequently, the labor-saving efficacy is enhanced.

In an embodiment, the slide switch includes a position-limiting structure. The position-limiting structure includes a position-limiting groove and a supporting block. The position-limiting groove is formed in the casing. A first side of the supporting block is movably connected with the position-limiting groove. An accommodation space is formed between the supporting post and the supporting arm. A second side of the supporting block away from the position-limiting groove is movable within the accommodation space. In an embodiment, the position-limiting groove includes a first groove and a second groove. The first groove and the second groove are in communication with each other. The second groove is arranged between the first groove and the sensing element. The supporting block is movable within the first groove and the second groove. Consequently, the function of movably positioning the slider member is achieved.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating a slide switch according to a first embodiment of the present invention;

FIG. 2 is a schematic view illustrating a first usage scenario of the slide switch according to the first embodiment of the present invention;

FIG. 3 is a schematic view illustrating a second usage scenario of the slide switch according to the first embodiment of the present invention;

FIG. 4 is a schematic view illustrating a usage scenario of a slide switch according to a second embodiment of the present invention; and

FIG. 5 is a schematic view illustrating a usage scenario of a slide switch according to a third embodiment of the present invention.

### DETAILED DESCRIPTION OF THE PREFERRED EMBODIMENT

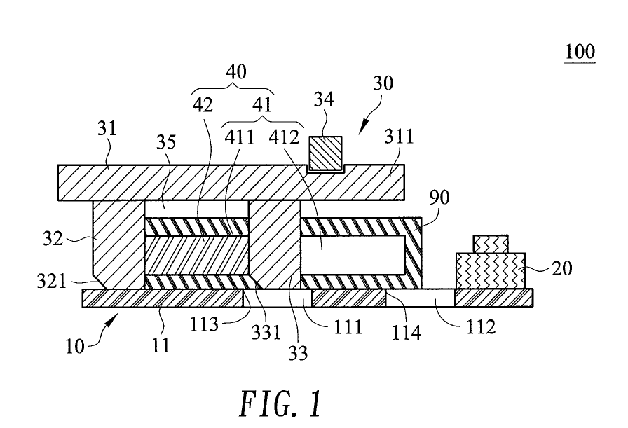

FIG. 1 is a schematic view illustrating a slide switch according to a first embodiment of the present invention. As shown in FIG. 1, the slide switch 100 is installed in a casing 90. The casing 90 is a casing of an electronic device. Alternatively, the slide switch 100 is installed in a covering member that is disposed within the casing. An example of the electronic device includes but is not limited to a mouse or a keyboard. In this embodiment, the slide switch 100 comprises a circuit board assembly 10, a sensing element 20, a slider member 30 and a position-limiting structure 40.

The circuit board assembly 10 is fixed on the casing 90. The circuit board assembly 10 comprises a main circuit board 11. The main circuit board 11 has an opening 111 and a perforation 112. The sensing element 20 is installed on the main circuit board 11 and electrically connected with the main circuit board 11. The sensing element 20 is disposed on the main circuit board 11 and located away from the opening 111. The perforation 112 is arranged between the sensing element 20 and the opening 111. The opening 111, the perforation 112 and the sensing element 20 are separated from each other. In an embodiment, the sensing element 20 is a tact switch.

The slider member 30 is movably connected with the main circuit board 11 and located away from the sensing element 20. The slider member 30 can be moved along the main circuit board 11. In this embodiment, the slider member 30 comprises a slider plate 31, a supporting post 32, a supporting arm 33 and an operation part 34. The slider plate 31 is in parallel with the main circuit board 11. The supporting post 32 and the supporting arm 33 are protruded from the slider plate 31 in the direction toward the main circuit board 11. An accommodation space 35 is formed between the supporting post 32 and the supporting arm 33. The slider plate 31 comprises a pressing part 311 at the side away from the supporting post 32 and the supporting arm 33. The sensing element 20 can be pressed by the pressing part 311. The supporting post 32 is located beside the opening 111 of the main circuit board 11 and away from the sensing element 20. The supporting arm 33 is arranged between the supporting post 32 and the pressing part 311. The supporting post 32, the supporting arm 33 and the pressing part 311 are separated from each other. The supporting post 32 is movable to the position within the opening 111 of the main circuit board 11. The supporting arm 33 is movable to the position within the perforation 112 of the main circuit board 11. The supporting post 32 and the supporting arm 33 have guiding slants 321 and 331, respectively. The guiding slant 321 is formed on a lower part of the supporting post 32 and at the side away from the sensing element 20. The guiding slant 331 is formed on a lower part of the supporting arm 33 and at the side away from the sensing element 20. Moreover, an upper corner 113 is located in the opening 111 of the main circuit board 11. The upper corner 113 and the guiding slant 321 of the supporting post 32 are movably connected with each other. Moreover, an upper corner 114 is formed in the perforation 112 of the main circuit board 11. The upper corner 114 and the guiding slant 331 of the supporting arm 33 are movably connected with each other. The operation part 34 is connected with the slider plate 31 and disposed on a top surface of the slider plate 31.

In this embodiment, the position-limiting structure 40 comprises a position-limiting groove 41 and a supporting block 42. The position-limiting groove 41 is formed in the casing 90. A first side of the supporting block 42 is movably connected with the position-limiting groove 41. A second side of the supporting block 42 is movable relative to the supporting post 32 and the supporting arm 33 and within the accommodation space 35. The position-limiting groove 41 comprises a first groove 411 and a second groove 412. The first groove 411 and the second groove 412 are in communication with each other. The second groove 412 is arranged between the first groove 411 and the sensing element 20. Consequently, the supporting block 42 can be moved within the first groove 411 and the second groove 412. Since the supporting block 42 is movable within the first groove 411 and the second groove 412, the function of movably positioning the slider member 30 is achieved.

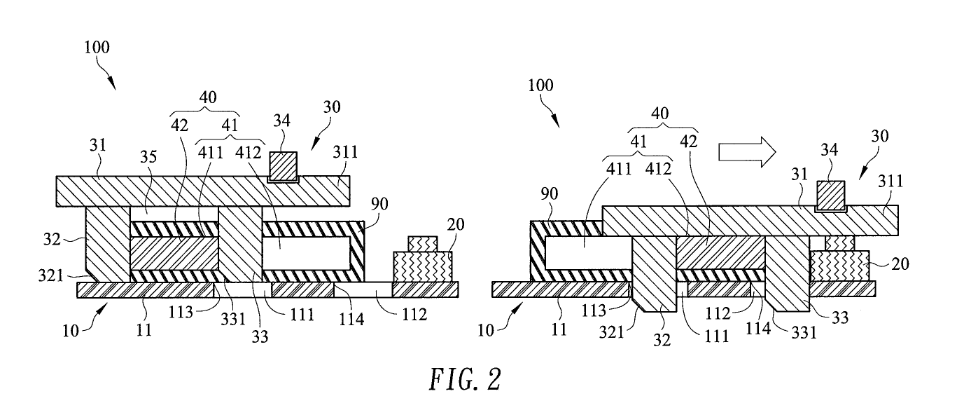

FIG. 2 is schematic view illustrating a first usage scenario of the slide switch according to the first embodiment of the present invention. When a depressing force is applied to the operation part 34 and the operation part 34 is moved in the direction toward the sensing element 20, the slider member 30 is moved along the main circuit board 11 in the direction toward the sensing element 20. Moreover, the supporting block 42 is moved with the supporting post 32 and the supporting arm 33. When the supporting block 42 is moved from the first groove 411 to the second groove 412, the pressing part 311 of the slider plate 31 is moved to the position over the sensing element 20. At the same time, the lower part of the supporting post 32 with the guiding slant 321 is inserted into the opening 111 of the main circuit board 11, and the lower part of the supporting arm 33 with the guiding slant 331 is inserted into the perforation 112 of the main circuit board 11. Consequently, the slider plate 31 is moved downwardly toward the sensing element 20. That is, the pressing part 311 of the slider plate 31 is moved toward the sensing element 20 to press the sensing element 20. When the depressing force from the pressing part 311 is received by the sensing element 20, the slide switch 100 is changed from a first function mode to a second function mode.

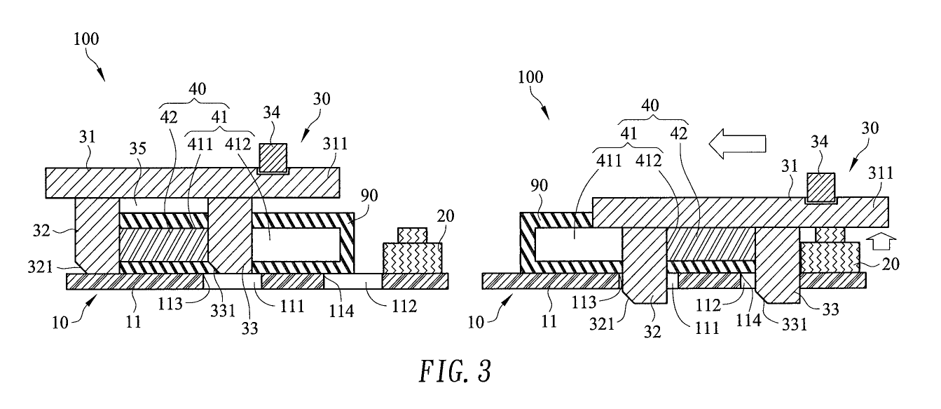

FIG. 3 is a schematic view illustrating a second usage scenario of the slide switch according to the first embodiment of the present invention. For returning the slider member 30 to its original position, the operation part 34 is moved in the direction away from the sensing element 20. Consequently, the slider member 30 is moved along the main circuit board 11 from the nearby position of the sensing element 20 to the distant position of the sensing element 20. As the supporting block 42 is moved with the supporting post 32 and the supporting arm 33, the supporting block 42 is moved from the second groove 412 to the first groove 411. At the same time, the lower part of the supporting post 32 with the guiding slant 321 is escaped from the opening 111 of the main circuit board 11, and the lower part of the supporting arm 33 with the guiding slant 331 is escaped from the perforation 112 of the main circuit board 11. Consequently, the slider member 30 is returned to its original position. Meanwhile, the slide switch 100 is changed from the second function mode to the first function mode.

From the above descriptions, the movement of the slider member 30 can switch the operation mode of the slide switch 100 between the first function mode and the second function mode. Moreover, since the slider member 30 is moved relative to the circuit board assembly 10 to achieve the mode-switching function, the structure of the slide switch 100 is simplified and the volume of the layout space of the slide switch 100 is reduced. Since the efficacy of saving the layout space is enhanced, the slide switch 100 is suitably installed in the electronic device with smaller space.

When the slider member 30 is moved in the direction away from the sensing element 20, the depressing force applied to the operation part 34 is eliminated. Due to an elastic effect from an elastic structure within the sensing element 20, the pressing part 311 is moved upwardly. As mentioned above, the guiding slant 321 of the supporting post 32 and the upper corner 113 in the opening 111 of the main circuit board 11 are movably connected with each other, and the guiding slant 331 of the supporting arm 33 and the upper corner 114 in the perforation 112 of the main circuit board 11 are movably connected with each other. Consequently, the force applied to the slider member 30 is reduced. Since the force for operating the slide switch 100 is reduced, the labor-saving efficacy is enhanced.

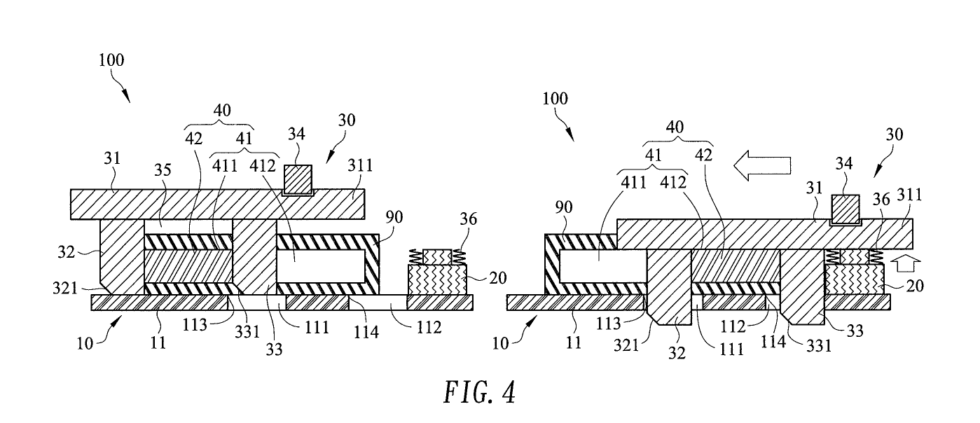

FIG. 4 is a schematic view illustrating a usage scenario of a slide switch according to a second embodiment of the present invention. In comparison with the first embodiment, the slider member 30 of this embodiment further comprises a restoring element 36. The restoring element 36 is sheathed around the sensing element 20. An end of the restoring element 36 away from the sensing element 20 is also pressed by the pressing part 311 of the slider plate 31. In an embodiment, the restoring element 36 is a spring or any other comparable element. When the slider member 30 is moved in the direction away from the sensing element 20, the depressing force applied to the operation part 34 is eliminated. Due to the elastic effect from the restoring element 36, the pressing part 311 is moved upwardly. Since the force applied to the slider member 30 is reduced, the labor-saving efficacy is enhanced.

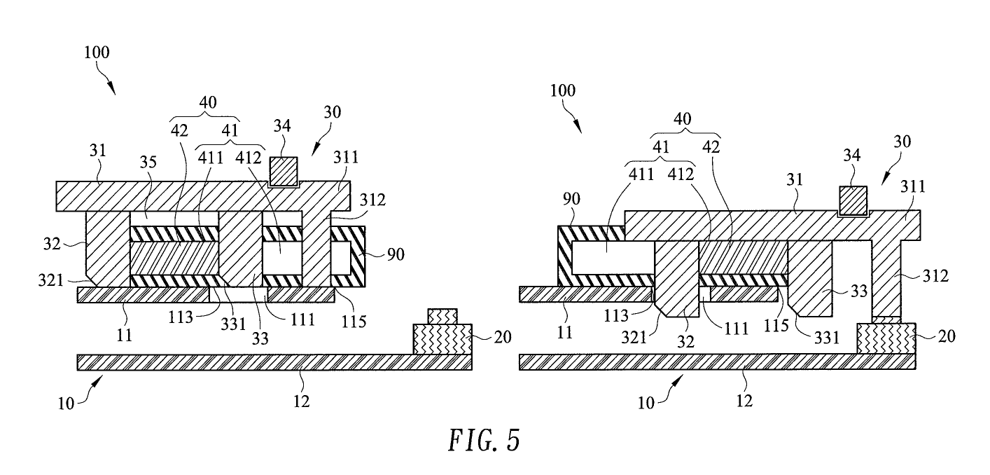

FIG. 5 is a schematic view illustrating a usage scenario of a slide switch according to a third embodiment of the present invention. In comparison with the above embodiments, the circuit board assembly 10 of this embodiment further comprises an auxiliary circuit board 12. The auxiliary circuit board 12 is located under the main circuit board 11. Moreover, the auxiliary circuit board 12 is electrically connected with the main circuit board 11. In this embodiment, the main circuit board 11 has the opening 111 only. That is, the perforation is not formed in the main circuit board 11. The sensing element 20 is installed on the auxiliary circuit board 12 and electrically connected with the auxiliary circuit board 12. The pressing part 311 further comprises a pressing post 312. The pressing post 312 is protruded from the slider plate 31 in a direction toward the main circuit board 11. The sensing element 20 beside the main circuit board 11 can be pressed by the pressing post 312. Moreover, an upper corner 115 is formed on an edge of the main circuit board 11 close to the sensing element 20. The upper corner 115 and the guiding slant 331 of the supporting arm 33 are movably connected with each other.

When a depressing force is applied to the operation part 34 and the operation part 34 is moved in the direction toward the sensing element 20, the slider member 30 is moved along the main circuit board 11 in the direction toward the sensing element 20. Moreover, the supporting block 42 is moved with the supporting post 32 and the supporting arm 33. When the supporting block 42 is moved from the first groove 411 to the second groove 412, the pressing post 312 of the slider plate 31 is moved to the position over the sensing element 20. At the same time, the lower part of the supporting post 32 with the guiding slant 321 is inserted into the opening 111 of the main circuit board 11, and the lower part of the supporting arm 33 with the guiding slant 331 is descended to the position between the main circuit board 11 and the sensing element 20 and movably connected with the edge of the main circuit board 11 beside the sensing element 20. Consequently, the pressing post 312 of the slider plate 31 is moved downwardly toward the sensing element 20 to press the sensing element 20. When the depressing force from the pressing post 312 is received by the sensing element 20, the slide switch 100 is changed from a first function mode to a second function mode.

For returning the slider member 30 to its original position, the operation part 34 is moved in the direction away from the sensing element 20. Consequently, the slider member 30 is moved along the main circuit board 11 from the nearby position of the sensing element 20 to the distant position of the sensing element 20. At the same time, the lower part of the supporting post 32 with the guiding slant 321 is escaped from the opening 111 of the main circuit board 11, and the lower part of the supporting arm 33 with the guiding slant 331 is returned from the nearby position of the sensing element 20 to the main circuit board 11. Consequently, the slider member 30 is returned to its original position. Meanwhile, the slide switch 100 is changed from the second function mode to the first function mode. That is, the movement of the slider member 30 can switch the operation mode of the slide switch 100 between the first function mode and the second function mode.

As mentioned above, the guiding slant 321 of the supporting post 32 and the upper corner 113 in the opening 111 of the main circuit board 11 are movably connected with each other, and the guiding slant 331 of the supporting arm 33 and the upper corner 115 of the main circuit board 11 beside the sensing element 20 are movably connected with each other. Since the force applied to the slider member 30 is reduced, the labor-saving efficacy is enhanced. In this embodiment, the sensing element 20 is installed on the auxiliary circuit board 12. Consequently, the circuit board assembly 10, the sensing element 20 and the slider member 30 are arranged in the vertical layout space in replace of the horizontal layout space. Since the layout space of the slide switch 100 is further saved, the slide switch 100 can be installed in the electronic device that has an insufficient horizontal space.

From the above descriptions, the slide switch of the present invention has the following features. Firstly, the combination of the circuit board assembly 10, the sensing element 20, the slider member 30 and the position-limiting structure 40 can simplify the structure and the layout space of the slide switch 100. Secondly, the use of the guiding slant 321 of the supporting post 32, the guiding slant 331 of the supporting arm 33, the elastic structure of the sensing element 20 or the elastic element 35 in the slide switch 100 can enhance the labor-saving efficacy. Thirdly, since the sensing element 20 is installed on the auxiliary circuit board 12, the horizontal layout space is saved.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A slide switch installed in a casing, the slide switch comprising:
a circuit board assembly fixed in the casing, wherein the circuit board assembly has an opening;
a sensing element installed on the circuit board assembly and electrically connected with the circuit board assembly, wherein the sensing element is on a first side of the opening; and
a slider member movably connected with the circuit board assembly and located away from the sensing element, wherein the slider member is movable along the circuit board assembly, and the slider member comprises a slider plate and a supporting post, wherein the supporting post is protruded from the slider plate in a direction toward the circuit board assembly, the slider plate comprises a pressing part for pressing the sensing element, the supporting post is on a second side of the opening away from the sensing element, and the supporting post is movable to a position within the opening.

2. The slide switch according to claim 1, wherein the circuit board assembly comprises a main circuit board, and the opening is formed in the main circuit board, wherein the sensing element is installed on the main circuit board and electrically connected with the main circuit board, wherein the slider member is movably connected with the main circuit board and movable along the main circuit board.

3. The slide switch according to claim 2, wherein the main circuit board further comprises a perforation between the opening and the sensing element, and the slider member further comprises a supporting arm, wherein the supporting arm is protruded from the slider plate in a direction toward the main circuit board, the supporting arm is arranged between the supporting post and the pressing part, and the supporting arm is movable to a position within the perforation.

4. The slide switch according to claim 3, wherein a first guiding slant is formed on a lower part of the supporting post and at a side away from the sensing element, a second guiding slant is formed on a lower part of the supporting atm and at a side away from the sensing element, a first upper corner is located in the opening of the main circuit board, and a second upper corner is formed in the perforation of the main circuit board, wherein the first guiding slant and the first upper corner are movably connected with each other, and the second guiding slant and the second upper corner are movably connected with each other.

5. The slide switch according to claim 1, wherein the circuit board assembly comprises a main circuit board and an auxiliary circuit board, wherein the auxiliary circuit board is located under the main circuit board, the auxiliary circuit board is electrically connected with the main circuit board, and the opening is formed in the main circuit board, wherein the sensing element is installed on the auxiliary circuit board and electrically connected with the auxiliary circuit board, wherein the slider member is movably connected with the main circuit board and movable along the main circuit board.

6. The slide switch according to claim 5, wherein the pressing part further comprises a pressing post, and the pressing post is protruded from the slider plate in a direction toward the main circuit board, wherein the sensing element beside the main circuit board is permitted to be pressed by the pressing post.

7. The slide switch according to claim 5, wherein the slider member further comprises a supporting arm, wherein the supporting arm is protruded from the slider plate in a direction toward the main circuit board, the supporting arm is arranged between the supporting post and the pressing post, and the supporting arm and an edge of the main circuit board close to the sensing element are movably connected with each other.

8. The slide switch according to claim 7, wherein a first guiding slant is formed on a lower part of the supporting post and at a side away from the sensing element, a second guiding slant is formed on a lower part of the supporting arm and at a side away from the sensing element, a first upper corner is located in the opening of the main circuit board, and a second upper corner is formed on an edge of the main circuit board close to the sensing element, wherein the first guiding slant and the first upper corner are movably connected with each other, and the second guiding slant and the second upper corner are movably connected with each other.

9. The slide switch according to claim 3, further comprising a position-limiting structure, wherein the position-limiting structure comprises a position-limiting groove and a supporting block, the position-limiting groove is formed in the casing, a first side of the supporting block is movably connected with the position-limiting groove, and an accommodation space is formed between the supporting post and the supporting arm, and a second side of the supporting block away from the position-limiting groove is movable within the accommodation space, wherein the position-limiting groove comprises a first groove and a second groove that are in communication with each other, the second groove is arranged between the first groove and the sensing element, and the supporting block is movable within the first groove and the second groove.

10. The slide switch according to claim 7, further comprising a position-limiting structure, wherein the position-limiting structure comprises a position-limiting groove and a supporting block, the position-limiting groove is formed in the casing, a first side of the supporting block is movably connected with the position-limiting groove, and an accommodation space is formed between the supporting post and the supporting arm, and a second side of the supporting block away from the position-limiting groove is movable within the accommodation space, wherein the position-limiting groove comprises a first groove and a second groove that are in communication with each other, the second groove is arranged between the first groove and the sensing element, and the supporting block is movable within the first groove and the second groove.

11. The slide switch according to claim 3, wherein the slider member further comprises an operation part, wherein the operation part is connected with the slider plate and disposed on a top surface of the slider plate.

12. The slide switch according to claim 7, wherein the slider member further comprises an operation part, wherein the operation part is connected with the slider plate and disposed on a top surface of the slider plate.

13. The slide switch according to claim 3, wherein the slider member further comprises a restoring element, and the restoring element is sheathed around the sensing element, wherein an end of the restoring element away from the sensing element is pressed by the pressing part, and the restoring element is a spring.

14. The slide switch according to claim 7, wherein the slider member further comprises a restoring element, and the restoring element is sheathed around the sensing element, wherein an end of the restoring element away from the sensing element is pressed by the pressing part, and the restoring element is a spring.

15. The slide switch according to claim 1, wherein the sensing element is a tact switch.
